(19) United States
(12) Patent Application Publication
(10) Pub. No.: US 2025/0146102 A1
(43) Pub. Date: May 8, 2025

(54) OXIDATIVE LEACHING METHODS

(71) Applicant: BASF SE, Ludwigshafen am Rhein (DE)

(72) Inventors: Wolfgang Rohde, Ludwigshafen (DE); Nils-Olof Joachim Born, Ludwigshafen (DE); Marc Duchardt, Ludwigshafen (DE); Vincent Smith, Midrand (ZA); Fabian Seeler, Ludwigshafen (DE); Anne-Marie Caroline Zieschang, Ludwigshafen (DE)

(73) Assignee: BASF SE, Ludwigshafen am Rhein (DE)

(21) Appl. No.: 18/833,533

(22) PCT Filed: Jan. 31, 2023
(86) PCT No.: PCT/EP2023/052353

§ 371 Date: Jul. 26, 2024

(30) Foreign Application Priority Data
Feb. 1, 2022 (EP) 22154535.3

(51) Int. Cl. C22B 15/00; H01M 10/54

(52) U.S. Cl. CPC C22B 15/0071; C22B 15/0073; H01M 10/54

(57) ABSTRACT

Disclosed are methods for leaching a material comprising copper in a zero oxidation state, wherein the method comprises contacting the material with an acidic aqueous solution having a pH less than 6 to form a leaching mixture, and oxidizing the copper with an oxidizing agent of formula LiₚM_{q}M′ᵣOₛ. M comprises one or more metals chosen from nickel, manganese, and cobalt, M′ comprises one or more metals chosen from Mg, Ca, Ba, Al, Ti, Zr, Zn, Fe, V, Mo, and W; p ranges from 1 to 1.4; q ranges from 0.6 to 2; r ranges from 0 to 1; s ranges from 2 to 4; and a total amount of copper present in the material before leaching in moles divided by a total amount of the oxidizing agent in moles, mols(Cu)/moIs(OA), ranges from n(^{e}M)/8 to 2 n(^{e}M); n(^{e}M)_=2(s-q)-p-r^{⋅}oxm′ and Ox_{M′} is the average oxidation number of M′ determined by calculating the molar average of the most stable oxidation number for each metal, as an oxide, comprised by M′.

The project leading to this application has received funding from Bundesministerium für Wirtschaft und Klimaschutz (DE; FKZ:16BZF101A); the applicant bears responsibility for all disclosures herein.

### FIELD OF THE INVENTION

Disclosed are methods for leaching a material comprising copper in a zero oxidation state, wherein the method comprises contacting the material with an acidic aqueous solution having a pH less than 6 to form a leaching mixture, and oxidizing the copper with an oxidizing agent of formula LiₚM_{q}M′ᵣOₛ. Also disclosed are methods for recycling at least one battery material chosen from a lithium ion battery, lithium ion battery waste, lithium ion battery production scrap, lithium ion cell production scrap, lithium ion cathode active material, and combinations thereof. Also disclosed are methods of reducing a first material of formula LiₚM_{q}M′ᵣOₛ with a second material comprising copper in a zero oxidation state.

### BACKGROUND

High purity lithium is a valuable resource. Many sources of lithium, such as lithium ion batteries, lithium ion battery waste, lithium containing water, e.g. ground water, and raw lithium containing ores, are complex mixtures of various elements and compounds. The removal and purification of lithium from a material, such as a lithium ion battery material, are exemplary steps in the recycling of lithium ion batteries. Lithium ion battery materials are complex mixtures of various elements and compounds, and it may be desirable to remove various non-lithium impurities. Such impurities may exist in a variety of oxidation states which may impact, for example, the efficiency of a leaching process. For example, in some leaching processes high oxidation state metals may be more or less efficiently leached than low or zero oxidation state metals. Some non-lithium impurities are also valuable resources, and it may additionally be desirable to separate and purify various elements and compounds from such materials.

Accordingly, there is a need for processes for removing lithium from materials such as, for example, a battery material and processes for recycling lithium ion battery materials. For example, there is a need for leaching methods for efficiently and effectively leaching complex mixtures of various elements and compounds such as, for example, mixed metals coexisting in a variety of oxidation states. For example, there is a need for economic processes with high lithium recovery and high lithium purity. There is also a need for economic processes with high recovery and high purity for removing value metals such as, for example, copper, from materials.

CN 111 961 839 A discloses a method for leaching valuable metal from anode and cathode active materials of waste lithium ion batteries and removing impurities synchronously. The method specifically comprises the steps that the anode and cathode active materials of the waste lithium ion batteries are roasted, so that part of F and P impurities are removed; after roasting is finished, the roasted materials are treated in a two-stage acid leaching method for leaching the valuable metal and removing most F; and leaching liquid is treated in a chemical method so as to remove Fe, Al, Cu and remaining F, P and other impurities.

### SUMMARY OF THE INVENTION

Disclosed are methods for leaching a material comprising copper in a zero oxidation state, wherein the method comprises contacting the material with an acidic aqueous solution having a pH less than 6 to form a leaching mixture, and oxidizing the copper with an oxidizing agent (OA) of formula LiₚM_{q}M′ᵣOₛ. Here, M comprises one or more metals chosen from nickel, manganese, and cobalt, M′ comprises one or more metals chosen from Mg, Ca, Ba, Al, Ti, Zr, Zn, Fe, V, Mo, and W; p ranges from 1 to 1.4; q ranges from 0.6 to 2; r ranges from 0 to 1; s ranges from 2 to 4; and a total amount of copper present in the material before leaching in moles divided by a total amount of the oxidizing agent in moles, mols(Cu)/mols(OA), ranges from to n(e_{M})/8 to 2 n(e_{M});

$$n ( {e}_{M} ) = \frac{2 ( s - q ) - p - r \cdot {Ox}_{{M}^{′}}}{q} ;$$

and Ox_{M}, is the average oxidation number of M′ determined by calculating the molar average of the most stable oxidation number for each metal, as an oxide, comprised by M′.

Also disclosed are methods for recycling at least one battery material chosen from a lithium ion battery, lithium ion battery waste, lithium ion battery production scrap, lithium ion cell production scrap, lithium ion cathode active material, and combinations thereof, wherein the method comprises optionally, heat treating the at least one battery material at a temperature ranging from 350° C. to 900° C., mechanically comminuting the at least one battery material to obtain a black mass, optionally, sorting the black mass to obtain a fine fraction and a coarse fraction, and subjecting the black mass, optionally the fine fraction, the coarse fraction, or the fine fraction and the coarse fraction, to a leaching method disclosed herein.

Also disclosed are methods of reducing a first material of formula LiₚM_{q}M′ᵣOₛ with a second material comprising copper in a zero oxidation state, wherein the method comprises contacting the first material with an acidic aqueous solution having a pH less than 6 to form a mixture, and reducing the first material with the second material; wherein M comprises one or more metals chosen from nickel, manganese, and cobalt, M′ comprises one or more metals chosen from Mg, Ca, Ba, Al, Ti, Zr, Zn, Fe, V, Mo, and W; p ranges from 1 to 1.4; q ranges from 0.6 to 2; r ranges from 0 to 1; s ranges from 2 to 4; and a total amount of copper present in the second material before the reducing step in moles divided by a total amount of the first in moles, mols(Cu)/mols(OA), ranges from n(e_{M})/8 to 2 n(e_{M}); wherein,

$$n ( {e}_{M} ) = \frac{2 ( s - q ) - p - r \cdot {Ox}_{{M}^{′}}}{q}$$

and Ox_{M}, is the average oxidation number of M′ determined by calculating the molar average of the most stable oxidation number for each metal, as an oxide, comprised by M′.

### BRIEF DESCRIPTION OF THE DRAWINGS

FIG. 1 depicts an exemplary batch process consistent with some embodiments of the disclosure.

FIG. 2 depicts an exemplary continuous process consistent with some embodiments of the disclosure.

FIG. 3 depicts an XRD pattern of an exemplary black mass.

### DETAILED DESCRIPTION

Disclosed are methods for leaching a material comprising copper in a zero oxidation state, wherein the method comprises contacting the material with an acidic aqueous solution having a pH less than 6 to form a leaching mixture, and oxidizing the copper with an oxidizing agent of formula LiₚM_{q}M′ᵣOₛ; wherein M comprises one or more metals chosen from nickel, manganese, and cobalt, M′ comprises one or more metals chosen from Mg, Ca, Ba, Al, Ti, Zr, Zn, Fe, V, Mo, and W; p ranges from 1 to 1.4; q ranges from 0.6 to 2; r ranges from 0 to 1; s ranges from 2 to 4; and a total amount of copper present in the material before leaching in moles divided by a total amount of the oxidizing agent in mols(Cu)/mols(OA), ranges from n(e_{M})/8 to 2 n(e_{M});

$$n ( {e}_{M} ) = \frac{2 ( s - q ) - p - r \cdot {Ox}_{{M}^{′}}}{q} ;$$

and Ox_{M}, is the average oxidation number of M′ determined by calculating the molar average of the most stable oxidation number for each metal, as an oxide, comprised by M′.

In some embodiments, mols(Cu)/mols(OA) ranges from to n(e_{M}).

In some embodiments, the oxidizing agent comprises lithiated nickel cobalt manganese oxide of formula Li₍₁₊ₓ₎(NiₐCo_{b}Mn_{c}M_{d})₍₁₋ₓ₎O₂, wherein M is chosen from Mg, Ca, Ba, Al, Ti, Zr, Zn, Mo, V and Fe; zero≤x≤0.2; 0.1≤a≤0.95, zero≤b≤0.9, or 0.05<b≤0.5;zero≤c≤0.6; zero≤d≤0.1; and a+b+c+d=1.

In some embodiments, the oxidizing agent comprises lithiated nickel-cobalt aluminum oxides of formula Li[NiₕCoᵢAlⱼ]O₂₊ₜ, wherein h ranges from 0.8 to 0.95; i ranges from 0.1 to 0.3; j ranges from 0.01 to 0.10; and t ranges from zero to 0.4.

In some embodiments, the oxidizing agent comprises lithiated manganese oxides of formula Li₍₁₊ₓ₎Mn_{2-x-y-z}M_{y}M_{z}O₄, wherein x ranges from zero to 0.2; y+z ranges from zero to 0.1; and M is chosen from Al, Mg, Fe, Ti, V, Zr and Zn.

In some embodiments, the oxidizing agent comprises a compound of formula xLi_{(1+1/3)}M_{(2/3)}O₂·yLiMO₂·zLiM′O₂, wherein M comprises at least one metal of Mn, Ni, Co of oxidation state +4, M′ is at least one transition metal, and 0<x<1, 0<y<1, 0<z<1 and x+y+z=1.

In some embodiments, the material is a black mass from a lithium ion battery material and the oxidizing agent is a cathode active material.

In some embodiments, at least 50% of the oxidizing agent is added to the leaching mixture after the contacting step; optionally wherein, at the contacting step, hydrogen gas evolves and at least 50% of the oxidizing agent is added to the leaching mixture after the hydrogen gas evolution rate decreases to 10% of a maximal hydrogen gas evolution rate during the contacting step.

In some embodiments, the cathode active material oxidizes from 50% to 100% of the copper.

In some embodiments, the method further comprises adding an additional oxidizing agent comprising at least one chosen from O₂, N₂O, hydrogen peroxide, and peroxydisulfates to the leaching mixture; optionally wherein, at the contacting step, hydrogen gas evolves and the additional oxidizing agent is added to the leaching mixture after the hydrogen gas evolution rate decreases to 10% of a maximal hydrogen gas evolution rate during the contacting step.

In some embodiments, the method further comprising adding a reducing agent comprising at least one chosen from SO₂, metabisulfite salts, bisulfite salts, dithionate salts, thiosulfate salts, H₂O₂, and H₂ to the leaching mixture; optionally, wherein the reducing agent is added after at least 50% of the copper has been oxidized.

In some embodiments, the acidic aqueous solution comprises at least one acid chosen from H₂SO₄, methane sulfonic acid, and nitric acid.

In some embodiments, the acidic aqueous solution has an acid concentration ranging from 18 mol/L to 0.0001 mol/L.

In some embodiments, the material comprises from 0.1 weight % to 10 weight % copper by total weight of the material.

In some embodiments, an aqueous solution comprising metal ions is obtained by the method disclosed herein, and the metal ions are separated to obtain at least one essentially pure metal ion solution and/or at least one essentially pure solid metal ion salt.

### Definitions

As used herein, “a” or “an” entity refers to one or more of that entity, e.g., “a compound” refers to one or more compounds or at least one compound unless stated otherwise. As such, the terms “a” (or “an”), “one or more”, and “at least one” are used interchangeably herein.

As used herein, the term “material” refers to the elements, constituents, and/or substances of which something is composed or can be made.

As used herein, a “reducing agent” is a compound capable of reducing a metal oxide and/or a metal hydroxide. For example, some reducing agents are capable of reducing some metal oxides and/or some metal hydroxides but not others.

As used herein, an “oxidizing agent” is a compound capable of oxidizing a metal in a zero oxidation state. For example, some oxidizing agents are capable of oxidizing some metals in a zero oxidation state but not others.

As used herein, a “solution” is a combination of a fluid and one or more compounds. For example, each of the one or more compounds in the solution may or may not be dissolved in the fluid.

As used herein, an “essentially pure metal ion solution” is a solution comprising a metal ion, a counter ion, a solvent; wherein the total weight of the metal ion and counter ion is at least 50% by weight excluding the weight of solvent.

As used herein, an “essentially pure solid metal ion salt” is a solid comprising a metal ion and a counter ion; wherein the total weight of the metal ion and counter ion is at least 50% by weight of the solid excluding the weight of solvent.

As used herein, the term “sparging” refers to dispersing a gas through a liquid.

As used herein, the term “base” refers to a material capable of reacting with a hydronium ion and to increase the pH-value of an acidic solution.

As used herein, the term “standard electrode potential” has its common usage in the field of electro-chemistry and is the value of the electromotive force of an electrochemical cell in which molecular hydrogen under at 1 bar and 298.15 K is oxidized to solvated protons at the standard hydrogen electrode. The potential of the standard hydrogen electrode is zero Volts by definition. An exemplary reference is: Johnstone, A. H. “CRC Handbook of Chemistry and Physics—69th Edition Editor in Chief RC Weast, CRC Press Inc., Boca Raton, Florida, 1988.

### Materials

In some embodiments, a material comprises copper in a zero oxidation state. In some embodiments, the material comprises from 0.1 weight % to 30 weight % copper by total weight of the material. In some embodiments, the material comprises from 0.1 weight % to 20 weight % copper by total weight of the material. In some embodiments, the material comprises from 0.1 weight % to 10 weight % copper by total weight of the material. In some embodiments, the material comprises from 1 weight % to 10 weight % copper by total weight of the material.

In some embodiments, the material comprises from 0.1 weight % to 30 weight % lithium by total weight of the material. In some embodiments, the material comprises from 1 weight % to 20 weight % lithium by total weight of the material. In some embodiments, the material comprises from 5 weight % to 20 weight % lithium by total weight of the material.

In some embodiments, the material is a lithium ion battery material such as a black mass. In some embodiments, the material comprises a lithium ion battery material such as a black mass.

In some embodiments, the material comprises one or more chosen from nickel, cobalt, manganese, and combinations thereof.

In some embodiments, the material further comprises one or more metals in a zero oxidation state chosen from nickel, cobalt, aluminum, iron, manganese, rare earth metals, and combinations thereof.

In some embodiments, the material comprises: from 0.1 weight percent to 10 weight percent lithium, from 0 weight percent to 60 weight percent nickel, from 0 weight percent to 20 weight percent cobalt, from 0 weight percent to 20 weight percent copper, from 0 weight percent to 20 weight percent aluminum, from 0 weight percent to 20 weight percent iron, and from 0 weight percent to 20 weight percent manganese; wherein each weight percent is by total weight of the material.

In some embodiments, the material, or a precursor thereof, is pyrolyzed prior to leaching. In some embodiments, the pyrolysis is performed under an inert atmosphere, an oxidizing atmosphere, a reducing atmosphere, or a combination thereof.

“Black mass” refers to materials comprising lithium derived from, for example, a lithium ion battery, lithium ion battery waste, lithium ion battery production scrap, lithium ion cell production scrap, lithium ion cathode active material, and/or combinations thereof by mechanical processes such as mechanical comminution. For example, black mass may be derived from battery scrap by mechanically treating the battery scrap to obtain the active components of the electrodes such as graphite and cathode active material and may include impurities from the casing, electrode foils, cables, separator, and electrolyte. In some examples, the battery scrap may be subjected to a heat treatment to pyrolyze organic (e.g. electrolyte) and polymeric (e.g. separator and binder) materials. Such a heat treatment may be performed before or after mechanical comminution of the battery material. In some embodiments, the black mass is subjected to a heat treatment.

Lithium ion batteries may be disassembled, punched, milled, for example in a hammer mill, rotor mill, and/or shredded, for example in an industrial shredder. From this kind of mechanical processing the active material of the battery electrodes may be obtained. A light fraction such as housing parts made from organic plastics and aluminum foil or copper foil may be removed, for example, in a forced stream of gas, air separation or classification or sieving.

Battery scraps may stem from, e.g., used batteries or from production waste such as off-spec material. In some embodiments a material is obtained from mechanically treated battery scraps, for example from battery scraps treated in a hammer mill a rotor mill or in an industrial shredder. Such material may have an average particle diameter (D50) ranging from 1 μm to 1 cm, such as from 1 μm to 500 μm, and further for example, from 3 μm to 250 μm.

Larger parts of the battery scrap like the housings, the wiring and the electrode carrier films may be separated mechanically such that the corresponding materials may be excluded from the battery material that is employed in the process. In some embodiments, the separation is done by manual or automated sorting. For example, magnetic parts can be separated by magnetic separation non-magnetic metals by eddy-current separators. Other techniques may comprise jigs and air tables.

Mechanically treated battery scrap may be subjected to a solvent treatment in order to dissolve and separate polymeric binders used to bind the transition metal oxides to current collector films, or, e.g., to bind graphite to current collector films. Suitable solvents are N-methylpyrrolidone, N,N-dimethyl-formamide, N,N-dimethylacetamide, N-ethylpyrrolidone, and dimethylsulfoxide, in pure form, as mixtures of at least two of the foregoing, or as a mixture with 1% to 99% by weight of water.

In some embodiments, mechanically treated battery scrap may be subjected to a heat treatment in a wide range of temperatures under different atmospheres. In some embodiments, the temperature ranges from 100° C. to 900° C. In some embodiments, lower temperatures below 300° C. may serve to evaporate residual solvents from the battery electrolyte, at higher temperatures the binder polymers may decompose while at temperatures above 400° C. the composition of the inorganic materials may change as some transition metal oxides may become reduced either by the carbon contained in the scarp material or by introducing reductive gases. In some embodiments, a reduction of lithium metal oxides may be avoided by keeping the temperature below 400° C. and/or by removing carbonaceous materials before the heat treatment.

In some embodiments, the heat treatment is performed at a temperatures ranging from 350° C. and 900° C. In some embodiments, the heat treatment is performed at a temperatures ranging from 450° C. to 800° C. In some embodiments, the heat treatment is performed under an inert, oxidizing, or reducing atmosphere. In some embodiments, the heat treatment is performed under an inert or reducing atmosphere. In some embodiments, reducing agents are formed under the conditions of the heat treatment from pyrolyzed organic (polymeric) components. In some embodiments, reducing agents are formed by adding a reducing gas such as H₂ and/or CO.

In some embodiments, the material comprises nickel, cobalt, manganese, copper, aluminum, iron, phosphorus, or combinations thereof.

In some embodiments, the material has a weight ratio ranging from 0.01 to 10 of lithium to a total weight of nickel, cobalt, manganese, copper, aluminum, iron, and phosphorus. In some embodiments, wherein the material has a weight ratio ranging from 0.01 to 5 of lithium to a total weight of nickel, cobalt, manganese, copper, aluminum, iron, and phosphorus. In some embodiments, wherein the material has a weight ratio ranging from 0.01 to 2 of lithium to a total weight of nickel, cobalt, manganese, copper, aluminum, iron, and phosphorus. In some embodiments, wherein the material has a weight ratio ranging from 0.01 to 1 of lithium to a total weight of nickel, cobalt, manganese, copper, aluminum, iron, and phosphorus.

In some embodiments, a process for recycling lithium ion battery materials comprises mechanically comminuting at least one chosen from a lithium ion battery, lithium ion battery waste, lithium ion battery production scrap, lithium ion cell production scrap, lithium ion cathode active material, and combinations thereof to obtain a black mass.

### Oxidizing Agents:

In some embodiments, an oxidizing agent is of formula LiₚM_{q}M′ᵣOₛ.

In some embodiments, M comprises one or more metals chosen from nickel, manganese, and cobalt, M′ comprises one or more metals chosen from Mg, Ca, Ba, Al, Ti, Zr, Zn, Fe, V, Mo, and W; p ranges from 1 to 1.4; q ranges from 0.6 to 2; r ranges from 0 to 1; s ranges from 2 to 4.

In some embodiments, the oxidizing agent comprises lithiated nickel cobalt manganese oxide of formula Li₍₁₊ₓ₎(NiₐCo_{b}Mn_{c}M_{d})₍₁₋ₓ₎O₂, wherein: M′ is chosen from Mg, Ca, Ba, Al, Ti, Zr, Zn, Mo, V and Fe; zero≤x≤0.2; 0.1≤a≤0.95, zero≤b≤0.9, or 0.05<b≤0.5; zero≤c≤0.6; zero≤d≤0.1; and a+b+c+d=1. In some embodiments, the oxidizing agent comprises lithiated nickel-cobalt aluminum oxides of formula Li[NiₕCoᵢAlⱼ]O₂₊ₜ, wherein: h ranges from 0.8 to 0.95; i ranges from 0.1 to 0.3; j ranges from 0.01 to 0.10; and t ranges from zero to 0.4.

In some embodiments, the oxidizing agent comprises lithiated manganese oxides of formula Li₍₁₊ₓ₎Mn_{2-x-y-Z}M_{y}M′_{z}O4, wherein: x ranges from zero to 0.2; y+z ranges from zero to 0.1; and M is chosen from Al, Mg, Fe, Ti, V, Zr and Zn.

In some embodiments, the oxidizing agent comprises a compound of formula xLi_{(1+1/3)}M_{(2/3)}O₂·yLiMO₂·zLiM′O₂, wherein M comprises at least one metal of Mn, Ni, Co of oxidation state +4, M′ is at least one transition metal and 0<x<1, 0<y<1, 0<z<1 and x+y+z=1. In some embodiments, the oxidizing agent is a cathode active material.

In some embodiments, the oxidizing agent comprises at least one cathode active material chosen from lithiated nickel cobalt manganese oxide, lithiated nickel cobalt aluminum oxide, lithiated manganese oxide, lithium ion battery scrap comprising cathode active materials such as production waste from the production of cathode active materials, and combinations thereof.

In some embodiments, the lithiated metal oxide is employed as an oxidizing agent as part of a mixture. For example, a black mass may comprise cathode active material. In some embodiments, the amount of cathode active material in a black mass can be determined by known methods in the art. For example, one may determine the amount of cathode active material by XRD with Rietveld refinement allowing a quantitative evaluation of the amount of NCM.

Another method, for example, is a redox-titration where the material is reacted with a reductant e.g. potassium iodide according to the reaction: LiₚM_{q}M′ᵣOₛ+n(e_{M})J⁻⁺2sH⁺→pLi++qM²⁺+rM′^{(O×M′)+}+0.5n(e_{M})l₂+sH₂O; and the amount of iodine that is produced can be determined by titration with e.g. sodium thiosulfate to evaluate n(e_{M}).

In some embodiments wherein the lithiated metal oxide is part of a mixture, for example with a black mass, the mixture contains only limited amounts of materials capable of reducing the lithiated metal oxide other than copper in a zero oxidation state. For example, in some embodiments wherein the lithiated metal oxide is part of a mixture, the molar ratio of non-copper materials capable of reducing the lithiated metal oxide to copper in a zero oxidation state is less than 3:1, e.g. less than 1:1, e.g. less than 1:4. In some embodiments, non-copper materials capable of reducing the lithiated metal oxide comprise organic compounds such as alcohols, aldehydes, carboxylic acids, esters, and/or acetals which upon oxidation form the corresponding aldehydes, ketones, carboxylic acids, or carbon dioxide. For example, a black mass can contain residual constituents of the battery electrolyte solvents. In some embodiments, the amounts of non-copper reducing materials is less than 20 w % or less than w % or less than 5 w % of the mixture.

In some embodiments, the oxidizing agent comprises lithiated nickel cobalt manganese oxide of formula Li₁₊ₓ(NiₐCo_{b}Mn_{c}M¹_{d})₁₋ₓO₂, wherein M¹ is chosen from Mg, Ca, Ba, Al, Ti, Zr, Zn, Mo, V and Fe, zero≤x≤0.2, 0.1≤a≤0.95, zero≤b≤0.9 (such as 0.05<b≤0.5), zero≤c≤0.6, zero≤d≤0.1, and a+b+c+d=1. Exemplary lithiated nickel cobalt manganese oxides include Li(₁₊ₓ₎[Ni_{0.33}Co_{0.33}Mn_{0.33}]₍₁₋ₓ₎O₂, Li₍₁₊ₓ₎[Ni_{0.5}CO_{0.2}Mn_{0.3}]₍₁₋ₓ₎O₂, Li₍₁₊ₓ₎[Ni_{0.6}Co_{0.2}Mn_{0.2}]₍₁₋ₓ₎O₂, Li₍₁₊ₓ₎[Ni_{0.7}Co_{0.2}Mn_{0.3}]₍₁₋ₓ₎O₂, Li₍₁₊ₓ₎[Ni_{0.8}Co_{0.1}Mn_{0.1}]₍₁₋ₓ₎O₂ each with x as defined above, and Li[Ni_{0.85}Co_{0.13}Al_{0.02}]O₂.

In some embodiments, the oxidizing agent comprises lithiated nickel-cobalt aluminum oxides of formula Li[NiₕCoᵢAlⱼ]O₂₊ₜ, wherein h ranges from 0.8 to 0.95, i ranges from 0.1 to 0.3, j ranges from 0.01 to 0.10, and t ranges from zero to 0.4.

In some embodiments, the oxidizing agent comprises LiₓMO₂; wherein x is an integer greater than or equal to one, and M is chosen from metals, transition metals, rare earth metals, and combinations thereof.

In some embodiments, the oxidizing agent comprises lithiated manganese oxides of formula Li(₁₊ₓ₎Mn_{2-x-y-Z}M_{y}M′_{z}O₄, wherein: x ranges from zero to 0.2; y+z ranges from zero to 0.1; and M is chosen from Al, Mg, Fe, Ti, V, Zr and Zn.

In some embodiments, the oxidizing agent comprises a compound of formula xLi_{(1+1/3)}M_{(2/3)}O₂·yLiMO₂·zLiM′O₂, wherein M comprises at least one metal of Mn, Ni, Co of oxidation state +4, M′ is at least one transition metal and 0<x<1, 0<y<1, 0<z<1 and x+y+z=1.

In some embodiments, an additional oxidizing agent is an acid such as, for example, H₂SO₄, HNO₃, and combinations thereof. In some embodiments, an oxidizing agent is not an acid such as, for example, O₂, N₂O, and combinations thereof.

In some embodiments, an additional oxidizing agent has a standard electrode potential ranging from +0.1 V to +1.5 V. In some embodiments, an oxidizing agent has a standard electrode potential ranging from +0.4 V to +1.3 V. In some embodiments, an oxidizing agent has a standard electrode potential ranging from +1 V to +1.5 V.

Reducing Agents: In some embodiments, the reducing agent is one or more chosen from SO₂, metabisulfite salts, bisulfite salts, dithionate salts, thiosulfate salts, H₂O₂, H₂, and combinations thereof.

In some embodiments, a reducing agent has a standard electrode potential ranging from +1 V to −0.5 V. In some embodiments, a reducing agent has a standard electrode potential ranging from +0.2 V to −0.3 V.

Hydrogen peroxide can function as reductant or oxidant, depending on the reaction partner. Possible oxidation and reduction reactions are: H₂O₂→O₂+2e⁻+2 H⁺, and H₂O₂+2e⁻+2 H⁺→2 H₂O. In some embodiments, the standard electrode potential of the reaction partner impacts which reaction occurs. For example, under certain conditions permanganate (MnO₄⁻) is reduced by hydrogen peroxide while Fe²⁺ is oxidized. In some embodiments, more acidic conditions benefit the oxidation reaction as H⁺ is needed to form water and less acidic conditions benefit the reduction reaction as H⁺ is produced during that reaction. In some embodiments, the following reactions may or may not occur depending on the one or more metals M and the conditions used: 2LiMO₂+H₂O₂+3H₂SO₄→2LiSO₄+2MSO₄+4H₂O+O₂, and M+H₂O₂+H₂SO₄→MSO₄+2H₂O.

### Acidic Aqueous Solutions:

In some embodiments, the acidic aqueous solution comprises at least one acid chosen from H₂SO₄, methane sulfonic acid, and nitric acid.

In some embodiments, the acidic aqueous solution has an acid concentration ranging from 18 mol/L to 0.0001 mol/L. In some embodiments, the acidic aqueous solution has an acid concentration ranging from 18 mol/L to 0.001 mol/L. In some embodiments, the acidic aqueous solution has an acid concentration ranging from 18 mol/L to 0.01 mol/L. In some embodiments, the acidic aqueous solution has an acid concentration ranging from 18 mol/L to 0.1 mol/L. In some embodiments, the acidic aqueous solution has an acid concentration ranging from 18 mol/L to 1 mol/L. In some embodiments, the acidic aqueous solution has an acid concentration ranging from 10 mol/L to 0.0001 mol/L. In some embodiments, the acidic aqueous solution has an acid concentration ranging from 1 mol/L to 0.0001 mol/L. In some embodiments, the acidic aqueous solution has an acid concentration ranging from 10 mol/L to 1 mol/L.

In some embodiments, the acidic aqueous solution comprises at least one chosen from H₂SO₄, O₂, N₂O, and combinations thereof. In some embodiments, the acidic aqueous solution comprises H₂SO₄. In some embodiments, the acidic aqueous solution comprises one or more acids chosen from H₂SO₄, CH₃SO₃H, HNO₃, and combinations thereof. In some embodiments, the acidic aqueous solution further comprises one or more chosen from O₂, N₂O, and combinations thereof. In some embodiments, the only oxidizing agent added to the acidic aqueous solution is a CAM material of formula LiₚM_{q}M′ᵣOₛ. In some embodiments, the acidic aqueous solution comprises an acid that is also an oxidizing agent such as, for example, H₂SO₄. In some embodiments, the acidic aqueous solution comprises an oxidizing agent that is not an acid such as, for example, O₂, N₂O, or combinations thereof. In some embodiments, the acidic aqueous solution comprises an acid and an oxidizing agent. In some embodiments, the acidic aqueous solution comprises an acid and an oxidizing agent of formula LiₚM_{q}M′ᵣOₛ. In some embodiments, the acidic aqueous solution comprises an acid that is also an oxidizing agent and further comprises an oxidizing agent that is not an acid.

### Methods for Leaching:

In some embodiments, a method for leaching a material comprising copper in a zero oxidation state is provided, wherein the method comprises: contacting the material with an acidic aqueous solution having a pH less than 6 to form a leaching mixture, and oxidizing the copper with an oxidizing agent of formula LiₚM_{q}M′ᵣOₛ; wherein: M comprises one or more metals chosen from nickel, manganese, and cobalt, M′ comprises one or more metals chosen from Mg, Ca, Ba, Al, Ti, Zr, Zn, Fe, V, Mo, and W; p ranges from 1 to 1.4; q ranges from 0.6 to 2; r ranges from 0 to 1; s ranges from 2 to 4; and a total amount of copper present in the material before leaching in moles divided by a total amount of the oxidizing agent in moles, mols(Cu)/mols (OA), ranges from to n(e_{M})/8 to 2 n(e_{M}); wherein

$$n ( {e}_{M} ) = \frac{2 ( s - q ) - p - r \cdot {Ox}_{{M}^{′}}}{q}$$

and Ox_{M}, is the average oxidation number of M′ determined by calculating the molar average of the most stable oxidation number for each metal, as an oxide, comprised by M′.

In some embodiments, mols(Cu)/mols(OA) ranges from to n(e_{M}).

In some embodiments, at least 50% of the oxidizing agent is added to the leaching mixture after the contacting step; optionally wherein, at the contacting step, hydrogen gas evolves and at least 50% of the oxidizing agent is added to the leaching mixture after the hydrogen gas evolution rate decreases to 10% of a maximal hydrogen gas evolution rate during the contacting step.

In some embodiments, at least 50% of the oxidizing agent is added to the leaching mixture after the contacting step; wherein, at the contacting step, hydrogen gas evolves and at least 50% of the oxidizing agent is added to the leaching mixture after the hydrogen gas evolution rate decreases to 10% of a maximal hydrogen gas evolution rate during the contacting step.

In some embodiments, at least 10% of the oxidizing agent is added to the leaching mixture after the contacting step; optionally wherein, at the contacting step, hydrogen gas evolves and at least 10% of the oxidizing agent is added to the leaching mixture after the hydrogen gas evolution rate decreases to 10% of a maximal hydrogen gas evolution rate during the contacting step.

In some embodiments, at least 10% of the oxidizing agent is added to the leaching mixture after the contacting step; wherein, at the contacting step, hydrogen gas evolves and at least 10% of the oxidizing agent is added to the leaching mixture after the hydrogen gas evolution rate decreases to 10% of a maximal hydrogen gas evolution rate during the contacting step.

In some embodiments, at least 90% of the oxidizing agent is added to the leaching mixture after the contacting step; optionally wherein, at the contacting step, hydrogen gas evolves and at least 90% of the oxidizing agent is added to the leaching mixture after the hydrogen gas evolution rate decreases to 10% of a maximal hydrogen gas evolution rate during the contacting step.

In some embodiments, at least 90% of the oxidizing agent is added to the leaching mixture after the contacting step; wherein, at the contacting step, hydrogen gas evolves and at least 90% of the oxidizing agent is added to the leaching mixture after the hydrogen gas evolution rate decreases to 10% of a maximal hydrogen gas evolution rate during the contacting step.

In some embodiments, the method further comprising adding an additional oxidizing agent comprising at least one chosen from O₂, N₂O, hydrogen peroxide, and peroxydisulfates to the leaching mixture; optionally wherein, at the contacting step, hydrogen gas evolves and the additional oxidizing agent is added to the leaching mixture after the hydrogen gas evolution rate decreases to 10% of a maximal hydrogen gas evolution rate during the contacting step.

In some embodiments, the method further comprising adding an additional oxidizing agent comprising at least one chosen from O₂, N₂O, hydrogen peroxide, and peroxydisulfates to the leaching mixture; wherein, at the contacting step, hydrogen gas evolves and the additional oxidizing agent is added to the leaching mixture after the hydrogen gas evolution rate decreases to 10% of a maximal hydrogen gas evolution rate during the contacting step.

In some embodiments, further comprising adding a reducing agent comprising at least one chosen from SO₂, metabisulfite salts, bisulfite salts, dithionate salts, thiosulfate salts, H₂O₂, and H₂ to the leaching mixture; optionally, wherein the reducing agent is added after at least 50% of the copper has been oxidized.

In some embodiments, further comprising adding a reducing agent comprising at least one chosen from SO₂, metabisulfite salts, bisulfite salts, dithionate salts, thiosulfate salts, H₂O₂, and H₂ to the leaching mixture; optionally, wherein the reducing agent is added after at least 10% of the copper has been oxidized.

In some embodiments, further comprising adding a reducing agent comprising at least one chosen from SO₂, metabisulfite salts, bisulfite salts, dithionate salts, thiosulfate salts, H₂O₂, and H₂ to the leaching mixture; optionally, wherein the reducing agent is added after at least 90% of the copper has been oxidized.

In some embodiments, the acidic aqueous solution comprises at least one acid chosen from H₂SO₄, methane sulfonic acid, and nitric acid.

In some embodiments, the acidic aqueous solution has an acid concentration ranging from 18 mol/L to 0.0001 mol/L. In some embodiments, the acidic aqueous solution has an acid concentration ranging from 18 mol/L to 0.001 mol/L. In some embodiments, the acidic aqueous solution has an acid concentration ranging from 18 mol/L to 0.01 mol/L. In some embodiments, the acidic aqueous solution has an acid concentration ranging from 18 mol/L to 0.1 mol/L. In some embodiments, the acidic aqueous solution has an acid concentration ranging from 18 mol/L to 1 mol/L. In some embodiments, the acidic aqueous solution has an acid concentration ranging from 10 mol/L to 0.0001 mol/L. In some embodiments, the acidic aqueous solution has an acid concentration ranging from 1 mol/L to 0.0001 mol/L. In some embodiments, the acidic aqueous solution has an acid concentration ranging from 10 mol/L to 1 mol/L.

In some embodiments, a method comprises: leaching a material according to a method disclosed herein to obtain an aqueous solution comprising metal ions, and separating the metal ions to obtain at least one essentially pure metal ion solution and/or at least one essentially pure solid metal ion salt.

In some embodiments, a method for recycling at least one battery material chosen from a lithium ion battery, lithium ion battery waste, lithium ion battery production scrap, lithium ion cell production scrap, lithium ion cathode active material, and combinations thereof is provided, wherein the method comprises: optionally, heat treating the at least one battery material at a temperature ranging from 350° C. to 900° C., mechanically comminuting the at least one battery material to obtain a black mass, optionally, sorting the black mass to obtain a fine fraction and a coarse fraction, and subjecting the black mass, optionally the fine fraction, the coarse fraction, or the fine fraction and the course fraction, to a leaching method disclosed herein.

In some embodiments, a method for recycling at least one battery material chosen from a lithium ion battery, lithium ion battery waste, lithium ion battery production scrap, lithium ion cell production scrap, lithium ion cathode active material, and combinations thereof is provided, wherein the method comprises: heat treating the at least one battery material at a temperature ranging from 350° C. to 900° C., mechanically comminuting the at least one battery material to obtain a black mass, and subjecting the black mass to a leaching method disclosed herein.

In some embodiments, a method for recycling at least one battery material chosen from a lithium ion battery, lithium ion battery waste, lithium ion battery production scrap, lithium ion cell production scrap, lithium ion cathode active material, and combinations thereof is provided, wherein the method comprises: optionally, heat treating the at least one battery material at a temperature ranging from 350° C. to 900° C., mechanically comminuting the at least one battery material to obtain a black mass and subjecting the black mass to a leaching method disclosed herein.

In some embodiments, a method of reducing a first material of formula LiₚM_{q}M′ᵣOₛ with a second material comprising copper in a zero oxidation state is provided, wherein the method comprises: contacting the first material with an acidic aqueous solution having a pH less than 6 to form a mixture, and reducing the first material with the second material; wherein: M comprises one or more metals chosen from nickel, manganese, and cobalt, M′ comprises one or more metals chosen from Mg, Ca, Ba, Al, Ti, Zr, Zn, Fe, V, Mo, and W; p ranges from 1 to 1.4; q ranges from 0.6 to 2; r ranges from 0 to 1; s ranges from 2 to 4; and a total amount of copper present in the second material before the reducing steps in moles divided by a total amount of the first in moles, mols(Cu)/mols(OA), ranges from n(e_{M}) to 2 n(e_{M}); wherein

$$n ( {e}_{M} ) = \frac{2 ( s - q ) - p - r \cdot {Ox}_{{M}^{′}}}{q}$$

and Ox_{M}, is the average oxidation number of M′ determined by calculating the molar average of the most stable oxidation number for each metal, as an oxide, comprised by M′.

In some embodiments, a black mass is slurred in water at a weight percentage of black mass by total weight of the slurry ranging from 5% to 30%. In some embodiments, the slurred black mass is contacted with an acidic aqueous solution having a pH less than 6. In some embodiments, the acidic aqueous solution having a pH less than 6 is formed from the slurried black mass by addition of acid and an oxidizing agent. In some embodiments, the weight ratio of H₂SO₄ in the acidic aqueous to black mass ranges from 1:1 to 2:1. In some embodiments, H₂SO₄ is added to adjust the pH during the contacting step.

In some embodiments, the black mass is provided as a slurry. In some embodiments, the black mass is provided as a slurry in water. In some embodiments, the black mass is provided as a slurry in aqueous side streams from subsequent treatment steps such as, for example, washing liquids from filters. In some embodiments, the black mass is provided as a solid.

In some embodiments, the cathode active material is provided as a slurry. In some embodiments, the cathode active material is provided as a slurry in water. In some embodiments, the cathode active material is provided as a slurry in aqueous side streams from subsequent treatment steps such as, for example, washing liquids from filters. In some embodiments, the cathode active material is provided as a solid.

In some embodiments, a method for leaching comprises: contacting the material with an acidic aqueous solution having a pH less than 6, and, subsequently, reducing one or more chosen from metal oxides, metal hydroxides, and combinations thereof with a reducing agent.

In some embodiments, the acidic aqueous solution comprises at least one chosen from H₂SO₄, O₂, N₂O, and combinations thereof. In some embodiments, the acidic aqueous solution comprises H₂SO₄. In some embodiments, the acidic aqueous solution comprises one or more acids chosen from H₂SO₄, CH₃SO₃H, HNO₃, and combinations thereof. In some embodiments, the acidic aqueous solution further comprises one or more chosen from O₂, N₂O, and combinations thereof. In some embodiments, the only oxidizing agent added to the acidic aqueous solution is a CAM material of formula LiₚM_{q}M′ᵣOₛ. In some embodiments, the acidic aqueous solution comprises an acid that is also an oxidizing agent such as, for example, H₂SO₄. In some embodiments, the acidic aqueous solution comprises an oxidizing agent that is not an acid such as, for example, O₂, N₂O, or combinations thereof. In some embodiments, the acidic aqueous solution comprises an acid and an oxidizing agent. In some embodiments, the acidic aqueous solution comprises an acid and an oxidizing agent of formula LiₚM_{q}M′ᵣOₛ. In some embodiments, the acidic aqueous solution comprises an acid that is also an oxidizing agent and further comprises an oxidizing agent that is not an acid.

In some embodiments, the reducing agent is one or more chosen from SO₂, metabisulfite salts, bisulfite salts, thiosulfate salts, dithionate salts, H₂O₂, H₂, and combinations thereof.

In some embodiments, the method further comprises adjusting the pH of the aqueous solution with a mixed hydroxide precipitate. In some embodiments, the method further comprises adjusting the pH of the aqueous solution with at least one compound chosen from a transition metal hydroxide, a transition metal carbonate. In some embodiments, the transition metals of the compound are already present in the black mass. In some embodiments, the transition metal hydroxide is a CAM precursor. In some embodiments, the transition metal hydroxide and/or transition metal carbonate is provided as a slurry. In some embodiments, the transition metal hydroxide and/or transition metal carbonate is provided as a slurry in water. In some embodiments, the transition metal hydroxide and/or transition metal carbonate is provided as a slurry in aqueous side streams from subsequent treatment steps such as, for example, washing liquids from filters. In some embodiments, the transition metal hydroxide and/or transition metal carbonate is provided as a solid.

In some embodiments, contacting the material with an acidic aqueous solution is performed at a temperature ranging from 50° C. to 110° C. In some embodiments, contacting the material with an acidic aqueous solution is performed for a duration ranging from 2 hours to 4 hours. In some embodiments, contacting the material with an acidic aqueous solution is performed at a first temperature and the oxidizing step is performed at a second temperature, and the second temperature ranges from 100% to 20% of the first temperature.

In some embodiments, contacting the material with an acidic aqueous solution is performed at a temperature ranging from 50° C. to 110° C. In some embodiments, contacting the material with an acidic aqueous solution is performed for a duration ranging from 2 hours to 4 hours. In some embodiments, contacting the material with an acidic aqueous solution is performed at a first temperature and the oxidizing step is performed at a second temperature, and the second temperature ranges from 100% to 20% of the first temperature and the reducing step is performed at a third temperature and the third temperature ranges from 80% to 20% of the first temperature.

In some embodiments, the acidic aqueous solution comprises air. In some embodiments, a gas comprising oxygen is not sparged through the leaching mixture. In some embodiments, the acidic aqueous solution does not comprise air. In some embodiments, the acidic aqueous solution comprises less than 1000 ppm of air. In some embodiments, the air comprises less than or equal to 3 volume % sulfur dioxide. In some embodiments, contacting the material with an acidic aqueous solution having a pH less than 6 comprises sparging air through the acidic aqueous solution. In some embodiments, the air is sparged through the acidic aqueous solution at a rate of up to 20% solution volume/min.

In some embodiments, the acidic aqueous solution has a pH ranging from −1.0 to 3.

In some embodiments, contacting the material with an acidic aqueous solution having a pH less than 6 comprises first contacting the material with an acid causing a formation of hydrogen gas and, subsequent to the formation of hydrogen gas, an oxidizing agent is added. In some embodiments, contacting the material with an acidic aqueous solution having a pH less than 6 comprises first contacting the material with an acid causing a formation of hydrogen gas, monitoring the formation of hydrogen gas by gas chromatography and/or hydrogen sensors, and, subsequent to the formation of hydrogen gas, adding an oxidizing agent. In some embodiments, contacting the material with an acidic aqueous solution having a pH less than 6 comprises first contacting the material with an acid causing a formation of hydrogen gas, monitoring the formation of hydrogen gas by gas chromatography and/or hydrogen sensors, and, when the concentration of hydrogen gas is less than 5 volume %, for example less than 1 volume % for example less than 0.1 volume %, adding an oxidizing agent.

In some embodiments, excess oxidizing gas O₂, such as in air, and/or N₂O is recycled from the off-gas back into the leaching reactor.

In some embodiments, the reducing agent comprises SO₂ and the SO₂ is purged through the solution at a rate of up to 20% solution volume/min for 1 hour to 3 hours. In some embodiments, the reducing agent comprises SO₂ and the SO₂ is provided as a mixture with O₂ or air containing 10% SO₂ or more. In some embodiments, the reducing agent comprises SO₂ and the SO₂ is not provided as a mixture with O₂ or air. In some embodiments, the reducing agent comprises SO₂ and the SO₂ is provided as pure gas having a purity of at least 90%, for example 99%, or as mixture with an inert gas such as, for example, nitrogen and/or argon.

In some embodiments, the reducing step is performed at ambient temperature.

In some embodiments, subsequent to the contacting step, the method further comprises adding a base. In some embodiments, the base is chosen from CaO, a hydroxide salt, a carbonate salt, and combinations thereof. In some embodiments, the hydroxide salt is chosen from LiOH, NaOH, KOH, NH₄OH, Ca(OH)₂, CaCO₃, Ni(OH)₂, Co(OH)₂, Mn(OH)₂, and combinations thereof.

In some embodiments, the method is performed batchwise.

In some embodiments, the method is performed continuously in at least two reaction vessels. In some embodiments, the method is performed continuously in, e.g., three, four, five, six, seven, or more reaction vessels. In some embodiments, the black mass is added to a first reaction vessel, the oxidizing agent is added to a second and/or a third reaction vessel, the cathode active material and/or mixed hydroxide precipitate is added to a fourth reaction vessel, and the reducing agent is added to a fourth, a fifth, and/or a sixth reaction vessel.

In some embodiments, excess sulfur dioxide is recycled from the off-gas back into the reactor.

In some embodiments, a reflux condenser is fitted to at least one reaction vessel.

In some embodiments, contacting the material with an acidic aqueous solution is carried out at ambient pressure. In some embodiments, the contacting the material with an acidic aqueous solution is carried out at an elevated pressure.

In some embodiments, the contacting step is at a temperature ranging from 20° C. to 100° C. for a duration ranging from 10 minutes to 10 hours. In some embodiments, the contacting step is at 100° C. for a duration ranging from 3 hours to 5 hours. In some embodiments, the contacting step is at 60° C. for a duration ranging from 3 hours to 5 hours. In some embodiments, the contacting step is at 25° C. for a duration ranging from 3 hours to 5 hours.

In some embodiments, the oxidizing step is at a temperature ranging from 20° C. to 100° C. for a duration ranging from 10 minutes to 10 hours. In some embodiments, the oxidizing step is at 100° C. for a duration ranging from 3 hours to 5 hours. In some embodiments, the oxidizing step is at 60° C. for a duration ranging from 3 hours to 5 hours. In some embodiments, the oxidizing step is at 25° C. for a duration ranging from 3 hours to 5 hours.

In some embodiments, the reducing step is at a temperature ranging from 20° C. to 100° C. for a duration ranging from 10 minutes to 10 hours. In some embodiments, the reducing step is at 100° C. for a duration ranging from 3 hours to 5 hours. In some embodiments, the reducing step is at 60° C. for a duration ranging from 3 hours to 5 hours. In some embodiments, the reducing step is at 25° C. for a duration ranging from 3 hours to 5 hours.

In some embodiments, the method comprises leaching a material as disclosed herein to obtain an aqueous solution comprising metal ions and separating the metal ions to obtain at least one essentially pure metal ion solution and/or at least one essentially pure solid metal ion salt.

In some embodiments, an essentially pure solid metal ion salt is a solid comprising a metal ion and a counter ion; wherein the total weight of the metal ion and counter ion is at least 50% by weight of the solid excluding the weight of solvent such as all water. In some embodiments, an essentially pure solid metal ion salt is a solid comprising a metal ion and a counter ion; wherein the total weight of the metal ion and counter ion is at least 70% by weight of the solid excluding the weight of solvent. In some embodiments, an essentially pure solid metal ion salt is a solid comprising a metal ion and a counter ion; wherein the total weight of the metal ion and counter ion is at least 80% by weight of the solid excluding the weight of solvent. In some embodiments, an essentially pure solid metal ion salt is a solid comprising a metal ion and a counter ion; wherein the total weight of the metal ion and counter ion is at least 90% by weight of the solid excluding the weight of solvent. In some embodiments, an essentially pure solid metal ion salt is a solid comprising a metal ion and a counter ion; wherein the total weight of the metal ion and counter ion is at least 95% by weight of the solid excluding the weight of solvent. In some embodiments, an essentially pure solid metal ion salt is a solid comprising a metal ion and a counter ion; wherein the total weight of the metal ion and counter ion is at least 99% by weight of the solid excluding the weight of solvent.

In some embodiments, an essentially pure metal ion solution is a solution comprising a metal ion, a counter ion, and a solvent; wherein the total weight of the metal ion and counter ion is at least 50% by weight of the solution excluding the weight of solvent. In some embodiments, an essentially pure metal ion solution is a solution comprising a metal ion, a counter ion, a solvent; wherein the total weight of the metal ion and counter ion is at least 70% by weight of the solution excluding the weight of solvent. In some embodiments, an essentially pure metal ion solution is a solution comprising a metal ion, a counter ion, a solvent; wherein the total weight of the metal ion and counter ion is at least 80% by weight of the solution excluding the weight of solvent. In some embodiments, an essentially pure metal ion solution is a solution comprising a metal ion, a counter ion, a solvent; wherein the total weight of the metal ion and counter ion is at least 90% by weight of the solution excluding the weight of solvent. In some embodiments, an essentially pure metal ion solution is a solution comprising a metal ion, a counter ion, a solvent; wherein the total weight of the metal ion and counter ion is at least 95% by weight of the solution excluding the weight of solvent. In some embodiments, an essentially pure metal ion solution is a solution comprising a metal ion, a counter ion, a solvent; wherein the total weight of the metal ion and counter ion is at least 99% by weight of the solution excluding the weight of solvent.

In some embodiments, separating the metal ions to obtain at least one essentially pure metal ion solution and/or at least one essentially pure solid metal ion salt comprises one or more of a solid/liquid separation, an extraction, a precipitation, a crystallization, and combinations thereof.

In some embodiments, the method can be performed in part or in whole as a continuous process controlled by sensors and actuators as part of a computer based process control system.

Electron Equivalents: Without wishing to be bound by theory, it is believed that during the leaching process electrons transfer from a metal in a zero oxidation state, such as, copper to the oxidizing agent of formula LiₚM_{q}M′ᵣOₛ. It is further believed that the number of electrons per mol oxidizing agent of formula LiₚM_{q}M′ᵣOₛ that may be transferred from, e.g., copper to the oxidizing agent of formula LiₚM_{q}M′ᵣOₛ is provided by the following formula:

$$n ( {e}_{M} ) = \frac{2 ( s - q ) - p - r \cdot {Ox}_{{M}^{′}}}{q}$$

where Ox_{M}, is the average oxidation number of M′ determined by calculating the molar average of the most stable oxidation number for each metal, as an oxide, comprised by M′.

The average oxidation number of M′ (Ox_{M},) is determined by calculating the molar average of the most stable oxidation number for each metal, as an oxide, comprised by M′. The most stable oxidation number of Mg as an oxide is 2. The most stable oxidation number of Ca as an oxide is 2. The most stable oxidation number of Ba as an oxide is 2. The most stable oxidation number of Al as an oxide is 3. The most stable oxidation number of Ti as an oxide is 4. The most stable oxidation number of Zr as an oxide is 4. The most stable oxidation number of Zn as an oxide is 2. The most stable oxidation number of Fe as an oxide is 3. The most stable oxidation number of V as an oxide is 5. The most stable oxidation number of Mo as an oxide is 6. The most stable oxidation number of W as an oxide is 6. The molar average is taken with respect to the one or more metals that M′ comprises.

For example, a Li₍₁₊ₓ₎(NiₐCo_{b}Mn_{c}M′_{d})₍₁₋ₓ₎O₂ with x=0.1, a=b=c=0.3 and d=0.1 and M′ being Zr with an oxidation no. of +4 can be also described as LiₚM_{q}M′ᵣOₛ with p=1.1, q=0.81 r=0.09 and s=2 and gives an n(e_{M})=1.14 (here and in the following examples n(e_{M}) is rounded to two digits after the decimal point).

For example, a Li₍₁₊ₓ₎(NiₐCo_{b}Mn_{c}M′_{d})₍₁₋ₓ₎O₂ with x=0.1, a=b=c=0.3 and d=0.1 and M′ consisting of 30 mol % Mg, 20 mol % Zr, 10 mol % V and 40 mol % W with an average oxidation no. of Ox_{M′}=0.3×2+0.2×4+0.1×5+0.4×6=4.3 can be also described as LiₚM_{q}M′ᵣOₛ with p=1.1, q=0.81 r=0.09 and s=2 and gives an n(e_{M})=1.10.

For example, a Li[NiₕCoᵢAlⱼ]O₂₊ₜ with h=0.9, i=0.1, j=0.05 and t=0.2 can be also described as LiₚM_{q}M′ᵣOₛ with p=1.1, q=1 r=0.05 and s=2.2 gives an n(e_{M})=1.25.

For example, a Li₍₁₊ₓ₎Mn_{2-x-y-z}M_{y}M′_{z}O₄ with x=0.2, y=z=0.05 and M′ being Mg with an oxidation no. of +2 can be also described as LiₚM_{q}M′ᵣOₛ with p=1.2, q=1.75 r=0.05 and s=4 gives an n(e_{M})=1.83. For example, xLi_{(1+1/3)}M_{(2/3)}O₂·yLiM′O₂·zLiM′O₂ with x=0.9, y=z=0.05 and M′ being W with an oxidation no. of +6 can be also described as LiₚM_{q}M′ᵣOₛ with p=1.3, q=0.65 r=0.05 and s=2 gives an n(e_{M})=1.69.

### Exemplary Batch Process:

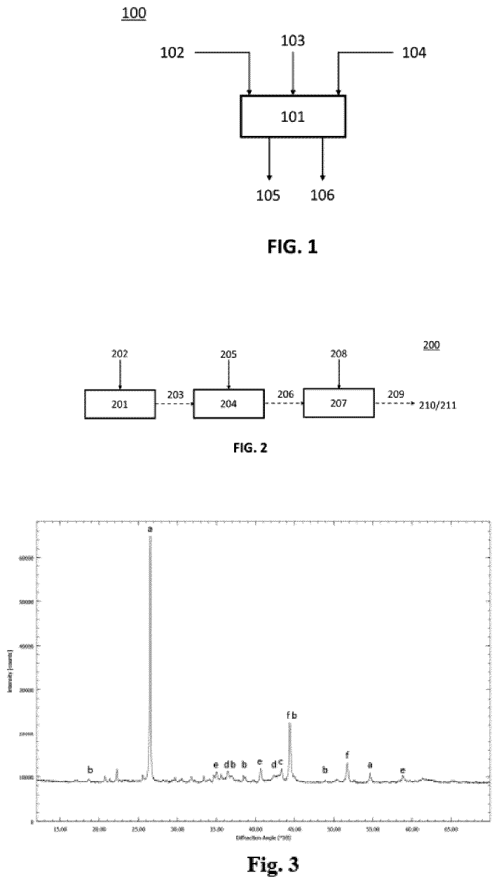

FIG. 1 depicts an exemplary batch process (100) consistent with some embodiments of the disclosure. In some embodiments, a material (102) such as a black mass comprising copper is acid leached in a continuously stirred reaction vessel (101) comprising an acidic aqueous solution at a pH less than 0. In some embodiments, hydrogen gas is evolved (105). In some embodiments, an oxidizing agent of formula LiₚM_{q}M′ᵣOₛ is added (103). In some embodiments, the pH is adjusted up to a pH ranging from 1 to 2 with, for example, mixed hydroxide precipitate and a reducing agent such as, for example, SO₂ is introduced (104). In some embodiments, the obtained liquid phase (106) and a solid phase (105) are separated by a solid/liquid separation e.g. filtration, centrifugation, and/or sedimentation.

### Exemplary Continuous Process:

FIG. 2 depicts an exemplary continuous process (200) consistent with some embodiments of the disclosure. In some embodiments, a material (202) such as a black mass comprising copper is acid leached in continuously stirred reaction vessel (201) comprising an acidic aqueous solution at a pH less than 0. In some embodiments, the acid leaching is further carried out in one or more additional continuously stirred reaction vessels (203). In some embodiments, an oxidizing agent of formula LiₚM_{q}M′ᵣOₛ is added (205) to a continuously stirred reaction vessel (204). In some embodiments, the acid leaching in the presence of an added oxidizing agent is further carried out in one or more additional continuously stirred reaction vessels (206). In some embodiments, the pH is adjusted up to a pH ranging from 1 to 2 with, for example, mixed hydroxide precipitate and a reducing agent such as, for example, SO₂ is introduced (208) to a continuously stirred reaction vessel (207). In some embodiments, the leaching in the presence of an added reducing agent is further carried out in one or more additional continuously stirred reaction vessels (209). In some embodiments, the obtained liquid phase (211) and a solid phase (210) are separated by a solid/liquid separation e.g. filtration, centrifugation, and/or sedimentation.

### EXAMPLES

The following examples are intended to be illustrative and are not meant in any way to limit the scope of the disclosure.

### Abbreviations

% percent
K₂CO₃ potassium carbonate
Na₂CO₃ sodium carbonate
Na₂B₄O₇ sodium tetraborate
p.a. grade pro analysis grade
n.d. not determined
wt % weight percent
NaOH sodium hydroxide
Li lithium
Ni nickel
Co cobalt
Mn manganese
Cu copper
Al aluminum
Fe iron
P phosphorus
F fluorine
Ca calcium

### Exemplary Elemental Analysis

Elemental analysis of solid samples was done by digestion in nitric acid and hydrochloric acid (feed samples and Examples 1 and 2) or digestion by K₂CO₃—Na₂CO₃/Na₂B₄O₇ fusion and dissolution of the fusion residue in hydrochloric acid (Examples 3 and 4).

The metals within the obtained sample solutions were determined by optical emission spectroscopy using an inductively coupled plasma (ICP-OES).

Elemental analysis of fluorine and fluoride was performed in accordance with DIN EN 14582:2016-12 with regard to the sample preparation for the overall fluorine content determination (waste samples); the detection method was an ion selective electrode measurement. DIN 38405-D4-2:1985-07 (water samples; digestion of inorganic solids with subsequent acid-supported distillation and fluoride determination using ion selective electrode).

Total carbon was determined by gas chromatography with a thermal conductivity detector of the gases obtained after combustion of the samples.

Sulfur was determined by catalytical combustion of the sample in an inert gas/oxygen atmosphere the sulfur is hereby converted to a mixture of SO₂ and SO₃. The formed SO₃ was subsequently reduced to SO₂ with copper granules. After drying and separation of the combustion gases, sulfur was detected and quantified as SO₂ via thermal conductivity or IR spectrometry.

### Black Mass

For the Examples provided below, the black mass was obtained by a process involving pyrolysis of battery scrap. The material contains low amounts of sulfur. The metals analyzed are present as oxidic compounds like MnO, CoO, NiO, as salts like LiF, LiAIO₂, Li₂CO₃, and/or as zero oxidation state metals like nickel, cobalt, and copper. The carbon is elemental carbon mainly in the form of graphite with some soot or coke.

The composition of the black mass 1, used in Examples 1-4, and black mass 2, used in Examples 5-7, are provided in Table 1.

TABLE 1

| | Black Mass 1 | Black Mass 2 |
|---|---|---|
| | Weight | Weight |
| Element | Percent | Percent |
| Al | 6.3 | 4.2 |
| Co | 6.6 | 5.9 |
| Cu | 4.2 | 4.1 |
| Fe | 2.3 | 0.3 |
| Li | 3.5 | 3.5 |
| Mn | 7.0 | 0.3 |
| Ni | 10.6 | 21.5 |
| C | 31.1 | 38.1 |
| S | 0.05 | 0.0 |

FIG. 3 depicts an XRD pattern of the black mass 1. In FIG. 3, “a” indicates graphite, “b” indicates nickel-cobalt-manganese, “c” indicates NiO, “d” indicates CoO, “e” indicates MnO, “f” indicates Ni, and the remaining reflections correspond to lithium salts and impurities.

Cathode Active Material of Formula LiₚM_{q}M′ᵣOₛ

The cathode active material (CAM) used in the Examples was a NCM111 type material containing approx. equimolar amounts of nickel, cobalt, and manganese. The composition of this material can be expressed as Li₍ₓ₊₁₎(Ni_{0.34}Co_{0.32}Mn_{0.34})₍₁₋ₓ₎O₂ with x=0.0628. The material can also be described as LiₚM_{q}M′ᵣOₛ with p=1.0682, q=0.9372 r=0 and s=2 giving an n(e_{M})=1.13. The formal average oxidation state of the nickel, cobalt, and manganese is +3.1340 i.e. 13.4% of the nickel, cobalt, and manganese are in the oxidation state +4 and 86.6% are in the oxidation state +3. The composition of the CAM was: 19.8 weight % Ni, 18.9 weight % Co, 18.3 weight % Mn, and 7.8 weight % Li.

### Example 1

In this example, black mass was contacted with an acidic aqueous solution having a pH less than 6, air as an oxidizing agent was added, but an oxidizing agent of formula LiₚM_{q}M′ᵣOₛ was not added. Subsequently, reducing agent SO₂ was added.

In a reaction vessel 162.37 g of black mass 1 was suspended in 348.65 g of de-ionized water under an atmosphere of argon. The reaction vessel was kept under a constant stream of 20 normal liters per hour of argon. To this mixture 227.32 g of sulfuric acid (96 w %) were slowly added over a period of about 45 min under stirring with a Rushton turbine at 500 rpm. The added acid corresponds to a calculated initial acid concentration (w/o reaction) of 39.5% and an acid to black mass ratio of 1.4. After the acid addition the reactor was heated to 100° C. within about 115 min. Hydrogen was evolved and the redox-potential of the solution was about −140 mV vs. Ag/AgCl₂. The hydrogen evolution was measured by an online gas chromatograph. At 152 min after the start of the sulfuric acid addition, the hydrogen evolution ceased and, during this time, a total of 8.2 normal liters of H₂ was evolved. This corresponds to 0.37 mole of hydrogen. After this, the reactor temperature was allowed to decrease to 80° C. which was reached after 30 min, and the redox-potential was observed to decreased to −180 mV. A sample of the reactor slurry was taken filtered and analyzed via X-ray fluorescence analysis. The filtrate contained 2.02% Ni, 1.296% Co, 1.367% Mn and 0.003% Cu.

Next, the gas supply was changed from argon to 20 normal liters per hour of air and the stirring speed was increased to 1200 rpm to ensure good gas-liquid mixing. Within 30 min the redox-potential increased to +83 mV and reached +131 mV after an additional 90 min. Next, another sample was taken from the reactor filtered and analyzed by X-ray fluorescence analysis. The filtrate was observed to contain 2.024% Ni, 1.283% Co, 1.348% Mn and 0.139% of Cu. Without wishing to be bound by theory, it is believed that the increase of the redox-potential by the addition of air increased the dissolution rate of copper significantly.

Subsequently, the reaction gas was changed from air to sulfur dioxide. After an additional 120 min under an atmosphere of sulfur dioxide the reaction mixture was cooled to room temperature and filtered. The filter residue was washed and dried affording 49.1 g of dry material. The composition and the corresponding elemental recoveries are provided in Table 2.

TABLE 2

| | Weight | Recovery |
|---|---|---|
| | Percent in | Percent |
| | Leach | in Leach |
| Element | Residue | Solution |
| Al | 3.0 | 85.6 |
| Co | 0.07 | 99.7 |
| Cu | 6.2 | 55.4 |
| Fe | 0.07 | 99.1 |
| Li | 0.11 | 99.0 |
| Mn | 0.04 | 99.8 |
| Ni | 0.15 | 99.6 |

### Example 2

In this example, black mass was contacted with an acidic aqueous solution having a pH less than 6, air as an oxidizing agent was added, and an oxidizing agent of formula LiₚM_{q}M′ᵣOₛ, here CAM of formula Li₍ₓ₊₁₎(Ni_{0.34}Co_{0.32}Mn_{0.34})₍₁₋ₓ₎O₂ with x=0.0628, was added. Subsequently, reducing agent SO₂ was added.

In a reaction vessel 174.13 g of black mass 1 was suspended in 337.21 g of de-ionized water under an atmosphere of argon. The reaction vessel was kept under a constant stream of 20 normal liters per hour of argon. To this mixture, 243.78 g of sulfuric acid (96 w %) was slowly added over a period of about 55 min under stirring with a Rushton turbine at 500 rpm. The added acid corresponds to a calculated initial acid concentration (w/o reaction) of 42.0% and an acid to black mass and CAM ratio of 1.35. After the acid addition, the reactor was heated to 100° C. within about 110 min. Hydrogen was evolved and the redox-potential of the solution is about −180 mV vs. Ag/AgCl₂. The hydrogen evolution was measured by an online gas chromatograph. At 110 min after the start of the sulfuric acid addition, the hydrogen evolution ceased, and during this time, a total of 7.7 normal liters H₂ were evolved. This corresponds to 0.34 mole of hydrogen. After this, the reactor temperature was allowed to decrease to 80° C. which was reached after 30 min. A sample of the reactor slurry was taken, filtered, and analyzed via X-ray fluorescence analysis. The filtrate contained 1.514% Ni, 0.941% Co, 1.838% Mn and 0.004% Cu.

Then the gas supply was changed from argon to 20 normal liters per hour of air and the stirring speed was increased to 1200 rpm to ensure good gas-liquid mixing. Within 30 min the redox-potential increased to +114 mV. At this point, 6.2 g of the CAM was added to the reaction mixture as dry powder. After another 90 min of stirring, another sample was taken from the reactor filtered and analyzed by X-ray fluorescence analysis. The filtrate was observed to contain 1.497% Ni, 0,888% Co, 1.615% Mn and 0.546% of Cu.

Subsequently, the reaction gas was changed from air to sulfur dioxide (about 3 g/h flow rate). After an additional 80 min under an atmosphere of sulfur dioxide corresponding to a total feed of about 4 g SO₂, the reaction mixture was cooled down to room temperature and filtered. The filter residue was washed and dried to afford 42.0 g of dry material. The composition and the corresponding elemental recoveries are given in Table 3.

TABLE 3

| | Weight | Recovery |
|---|---|---|
| | Percent in | Percent |
| | Leach | in Leach |
| Element | Residue | Solution |
| Al | 3.2 | 85.7 |
| Co | 0.48 | 98.1 |
| Cu | 0.19 | 98.7 |
| Fe | 0.31 | 96.2 |
| Li | 0.14 | 99.0 |
| Mn | 0.23 | 99.2 |
| Ni | 0.73 | 98.2 |

Comparing Example 1 and Example 2, Example 2 demonstrates that under similar reaction conditions the addition of CAM improves the copper recovery from 55% to 99%. Without wishing to be bound by theory, it is believed that in Example 2, 0.115 mole Cu, corresponding to 0.23 equivalents of electrons (Cu→Cu+2e⁻), are oxidized by 0.066 mole CAM

$$( i . e \frac{mol s ( Cu )}{mol s ( OA )} = 1.74 = 1.54 n ( {e}_{M} ) ) ,$$

corresponding to 0.075 equivalents of electrons (Li₍₁₊ₓ₎M(₁₋ₓ₎O₂+(1+x)/(1−x) e⁻→Li₂O+MO), and air.

### Example 3

In this example, black mass was contacted with an acidic aqueous solution having a pH less than 6, air was not added, and an oxidizing agent of formula LiₚM_{q}M′ᵣOₛ, here CAM of formula Li₍ₓ₊₁₎(Ni_{0.34}Co_{0.32}Mn_{0.34})₍₁₋ₓ₎O₂ with x=0.0628, was added. Subsequently, reducing agent SO₂ was added.

In a reaction vessel, 139.6 g of black mass 1 was suspended in 357.7 g of de-ionized water under an atmosphere of argon. The reaction vessel was kept under a constant stream of 20 normal liters per hour of argon. To this mixture, 208 g of sulfuric acid (96 wt %) were slowly added over a period of about 18 min under stirring with a Rushton turbine at 500 rpm. The added acid corresponds to a calculated initial acid concentration (w/o reaction) of 35.3% and an acid to black mass and CAM ratio of 1.34. After the acid addition, the reactor was heated to 100° C. within about 56 min. Hydrogen was evolved and the redox-potential of the solution was about −130 mV vs. Ag/AgCl₂. At 110 min after the start of the sulfuric acid addition, the hydrogen evolution ceased. A sample of the reactor slurry was taken, filtered. and analyzed via X-ray fluorescence analysis. The filtrate contained 1.909% Ni, 1.224% Co, 1.296% Mn and 0.007% Cu.

After an additional 11 min, 9 g of the CAM was added to the reaction mixture as a dry powder. After another 30 min of stirring, during which the reactor temperature was allowed to cool down to 80° C., another sample was taken from the reactor filtered and analyzed by X-ray fluorescence analysis. The filtrate was observed to contain 2,028% Ni, 1.349% Co, 1.416% Mn and 0.314% of Cu, and the pH-value was 0.04.

The reactor was kept for another 1 h at 80° C. under nitrogen during which the metal content in the solution was not observed to change significantly. The reactor was then cooled down to ambient temperature and kept overnight at this temperature under nitrogen.

The next day, the reactor was heated up to 80° C. The metal concentration in the solution had slightly increased to 2.149% Ni, 1.436% Co, 1.524% Mn and 0.364% Cu. At 67 min after attaining 80° C., the nitrogen flow was stopped and exchanged by a flow of 2.2 g/h pure sulfur dioxide gas. The Rushton turbine stirring speed was increased to 1200 rpm. The reactor was kept for another 120 min under these conditions corresponding to a total feed of 4.4 g SO₂.

Afterwards, the sulfur dioxide was exchanged by nitrogen, the stirrer speed was reduced to 500 min, and the heating of the reactor was stopped. When the reactor content reached room temperature the reactor content was filtered and the filter residue was washed and dried. The final filter residue had a mass of 41.1 g (corrected for the sample masses). The final composition of the filter residue and the corresponding metal recovery in the leach solution are summarized in Table 4.

TABLE 4

| | Weight | Recovery |
|---|---|---|
| | Percent in | Percent |
| | Leach | in Leach |
| Element | Residue | Solution |
| Al | 3.2 | 85.0 |
| Co | 0.04 | 99.8 |
| Cu | 2.3 | 83.9 |
| Fe | 0.48 | 93.9 |
| Li | 0.1 | 99.3 |
| Mn | 0.02 | 99.9 |
| Ni | 0.1 | 99.8 |

Without wishing to be bound by theory, it is believed that in Example 3 0.092 mole Cu, corresponding to 0.184 equivalents of electrons (Cu→Cu+2e⁻), are oxidized by 0.096 mole CAM

$$( i . e \frac{mol s ( Cu )}{mol s ( OA )} = 0.96 = 0.85 n ( {e}_{M} ) ) ,$$

corresponding to 0.109 equivalents of electrons (Li₍₁₊ₓ₎M₍₁₋ₓ₎O₂+(1+x)/(1−x)e⁻→Li₂O+MO), without any air.

### Example 4

For Example 4, the procedure of Example 3 was repeated except a lower amount of sulfuric acid and a higher SO₂ feed were used.

Thus, 139.6 g of black mass 1 was suspended in 386.0 g of de-ionized water under an atmosphere of argon. The reaction vessel was kept under a constant stream of 20 normal liters per hour of argon. To this mixture, 175 g of sulfuric acid (96 wt %) was slowly added over a period of about 20 min under stirring with a Rushton turbine at 500 rpm. The added acid corresponds to a calculated initial acid concentration (w/o reaction) of 30.0% and an acid to black mass and CAM ratio of 1.13. At 38 min after the addition of 9 g CAM, a sample of the liquid phase was analyzed. It contained 2.105% Ni, 1.411% Co, 1.48% Mn and 0.235% of Cu, and the pH-value was 0.7. 102 min after the CAM addition SO2 was fed to the reactor at 80° C. with a flow rate of 4.3 g/h corresponding to a total feed of 8.6 g SO₂ in 120 min. The results with respect to the final metal recoveries are summarized in Table. 5. The dried filter residue had a mass of 41.2 g.

TABLE 5

| | Weight | Recovery |
|---|---|---|
| | Percent in | Percent |
| | Leach | in Leach |
| Element | Residue | Solution |
| Al | 3.3 | 84.6 |
| Co | 0.07 | 99.7 |
| Cu | 7.4 | 48.0 |
| Fe | 0.08 | 99.0 |
| Li | 0.13 | 99.0 |
| Mn | 0.05 | 99.7 |
| Ni | 0.45 | 98.9 |

Without wishing to be bound by theory, it is believed that 0.092 mole Cu, corresponding to 0.184 equivalents of electrons (Cu→Cu+2e⁻), are oxidized by 0.096 mole CAM, corresponding to 0.109 equivalents of electrons (Li₍₁₊ₓ₎M₍₁₋ₓ₎O₂+(1+x)/(1−x) e⁻→Li₂O+MO), without any air. Comparing Example 3 and Example 4, an effect of acid concentration on the oxidation of copper by the CAM was observed.

### Example 5

In this example, black mass was contacted with an acidic aqueous solution having a pH less than 6, air was not added, and an oxidizing agent of formula LiₚM_{q}M′ᵣOₛ, here CAM of formula Li₍ₓ₊₁₎(Ni_{0.34}Co_{0.32}Mn_{0.34})₍₁₋ₓ₎O₂ with x=0.0628, was added. Subsequently, no reducing agent (SO₂) was added.

In a reaction vessel equipped with a reflux condenser and a dropping funnel, 1209.2 g of black mass 2 was suspended in 2883.1 g of de-ionized water under an atmosphere of nitrogen. The reaction vessel had been flushed with nitrogen and kept under a constant stream of 20 normal liters per hour of nitrogen throughout the whole experiment. To this mixture 1538.5 g of sulfuric acid (96 w %) were slowly added over a period of about 270 min under stirring with a threefold cross beam stirrer at 500 rpm at a starting temperature of 40° C. During this period, the temperature in the reactor was kept between 50° C. and 60° C. Hydrogen gas evolved and caused some foaming of the reaction mixture. For this reason, the acid addition and heating was slow. After the addition of the acid the temperature was kept at 50° C. for an additional 185 min then the reactor was cooled down and kept at room temperature overnight for an additional 855 min. Afterwards, the reaction mixture was heated up to 62° C. during additional 113 min and then another 225 g of sulfuric acid (96%) was added during 55 min. The added acid corresponds in total to a calculated initial acid concentration (w/o reaction) of 36.4% and an acid to black mass ratio of 1.3. After the completion of the acid addition the reactor was heated up to 100° C. within 169 min. The reactor content was kept at this temperature for another 53 min then a 1^{st} sample was taken, filtered and the washed filter residue was analyzed as wet filter cake by X-ray fluorescence analysis. The filter residue contained 0.69% Ni, 0.1% Co, 0.01% Mn and 2.13% Cu. The water content of the filter residue was about 50% indicating that most of the copper was likely not dissolved.

When the hydrogen gas evolution had cease, the reactor was allowed to cool down to 80° C., At 66 min after the first sample was taken, 80 g of pure CAM was added to the reaction mixture as dry powder. At 30 min after the addition of the CAM, a 2^{nd} sample was taken, filtered, and the washed wet filter residue was analyzed by X-ray fluorescence analysis. The residue contained 0.56% Ni, 0.09% Co, 0.01% Mn, and the Cu content was 0.618%.

An additional 8 g CAM was added, another sample was taken after additional 31 min. The Cu content of the washed wet filter residue had dropped to 0.56% while the sample contained 0.54% Ni, 0.08% Co and 0.01% Mn. Meanwhile, the reactor temperature had reached 80° C. Another 15 g of CAM was added, and another sample was taken after additional 30 min. The Cu content of the washed wet filter residue had only slightly dropped to 0.54%. The reactor was kept for an additional 21 min at 80° C., and then the reactor was cooled down and kept at room temperature overnight for an additional 882 min.

Afterwards, the reactor was re-heated to 80° C. within an additional 70 min. A fifth sample was taken to check any progress of the reaction over the night. The washed wet filter cake had a Cu content of 0.47% and the pH-value of the filtrate was 1.3. To increase the acidity of the reaction mixture, 100 g of sulfuric acid (96%) were added 40 min after the 5^{th} sampling. After another 35 min a sixth sample was taken, the washed wet filter residue now contained 0.37% Ni, 0.05% Co, 0.009% Mn and 0.34% Cu. After another 63 min, 11.5 g CAM was added. After an additional 93 min another portion of 11.5 g CAM was added to the reactor.

At 40 min after each of these additions, a sample was taken and the washed wet filter cake was analyzed, the Cu content was 0.29% and 0.11% respectively.

At 81 min after the latter sampling a ninth last sample was taken and the washed wet filter cake analyzed. The residue contained 0.26% Ni, 0.04% Co, 0.01% Mn and 0.13% Cu.

At this point, 1202 g de-ionized water was added. The reactor was allowed to cool down to room temperature and was kept at room temperature over the night. Then the reactor content was filtered, and the filter residue was washed in four portions with in total 3.906 g of de-ionized water. The wet filter cake had a mass of 847.5 g with a water content of 43.7%. The mass of the recovered filtrate was 5751 g. The total weight of the wash filtrates was 5182 g. The elemental composition of the filter residue and the calculated leaching recoveries are summarized in Table 6

TABLE 6

| | Weight | Recovery |
|---|---|---|
| | Percent in | Percent |
| | Leach | in Leach |
| Element | Residue | Solution |
| Al | 4.4 | 64.1 |
| Co | 0.11 | 99.4 |
| Cu | 0.52 | 95.0 |
| Fe | 0.006 | 99.0 |
| Li | 0.03 | 99.7 |
| Mn | 0.02 | 99.6 |
| Ni | 0.66 | 98.9 |

Without wishing to be bound by theory, it is believed that 0.78 mole Cu, corresponding to 1.56 equivalents of electrons (Cu→Cu+2e⁻), are oxidized by 1.35 mole CAM, corresponding to 1.53 equivalents of electrons (Li₍₁₊ₓ₎M₍₁₋ₓ₎O₂+(1+x)H⁺+(1+x)/(1−x) e⁻→+(1+x)/2 Li₂O+(1−x)MO+(1+x)/2 H₂O), without any air. The ratio (mol Cu)/(mol CAM) was 0.58 giving a n(e_{M}) of 0.51.

### Example 6

In this example, black mass was contacted with an acidic aqueous solution having a pH less than 6, air was not added, and an oxidizing agent of formula LiₚM_{q}M′ᵣOₛ, here CAM of formula Li₍ₓ₊₁₎(Ni_{0.34}Co_{0.32}Mn_{0.34})₍₁₋ₓ₎O₂ with x=0.0628, was added before the start of the sulfuric acid dosage. Subsequently, no reducing agent (SO₂) was added.

In a reaction vessel equipped with a reflux condenser and a dropping funnel 909.1 g of black mass 2 and 94.7 g of CAM was suspended in 2166 g of de-ionized water under an atmosphere of nitrogen. The amount of CAM added at the beginning of the reaction correspond to the calculated stoichiometric amount required for the dissolution of the copper contained in the reaction mixture. The reaction vessel had been flushed with nitrogen and kept under a constant stream of 20 normal liters per hour of nitrogen throughout the whole experiment.

The reactor content was heated up to 80° C. and then 1321 g of sulfuric acid (96 w %) was slowly added over a period of about 250 min under stirring with a threefold cross beam stirrer at 500 rpm at a starting temperature. During this period the temperature in the reactor was kept between at 80° C. Hydrogen gas evolved and caused some foaming of the reaction mixture. For this reason, the acid addition was slow. After the addition of the acid the temperature was kept at 80° C. for 25 min and then increased to 99° C. within 100 min. The reactor temperature was kept at 99° C. for additional 90 min. A 1^{st} sample was taken and analyzed, the wet filter residue contained 0.6% Ni, 0.08% Co, 0.006% Mn and 1.32% Cu while the filtrate contained 5.3% Ni, 2.1% Co, 0.5% Mn and 0.04% Cu. These data indicated that most of Ni, Co, and Mn of the black mass had dissolved already while the copper was leached only to a small extend.

Then, the reactor was cooled down and kept at room temperature overnight for an additional 925 min. Afterwards, the reaction mixture was heated up to 80° C. during an additional 72 min and 182 g of water and another 100 g of sulfuric acid (96%) were added during 9 min. After 13 min, 66.5 g of CAM was added to the reactor. After 52 min a 2^{nd} sample was taken and analyzed, the wet filter residue contained 0.44% Ni, 0.06% Co, 0.007% Mn and 0.64% Cu. At 23 min after the second sample was taken an additional 28.4 g of CAM was added to the reactor.

After another one hour a 3^{rd} sample was taken and analyzed. The wet filter residue contained 0.43% Ni, 0.06% Co, 0.01% Mn and 0.25% Cu while the filtrate contained 5.2% Ni, 2.3% Co, 0.8% Mn and 0.7% Cu.

At 25 min after the 3^{rd} sample was taken additional 30 g of sulfuric acid (96%) were added and the reactor contents was stirred for further 40 min. The added acid corresponded in total to a calculated initial acid concentration (w/o reaction) of 36.6% and an acid to black mass ratio of 1.3.

After this, the heating of the reactor was switched off, and 876 g of de-ionized water was added to so that metal salts did not crystallize upon cooling down to room temperature. The slurry was then filtered to obtain 4338 g of filtrate. The reactor was flushed with 847 g of water which was also filtered and unified with additional washing filtrates of the filter residue (in total 5318 g). The wet filter cake had a mass of 682 g with a water content of 42.0%. The elemental composition of the filter residue and the calculated leaching recoveries are summarized in table 7.

TABLE 7

| | Weight | Recovery |
|---|---|---|
| | Percent in | Percent |
| | Leach | in Leach |
| Element | Residue | Solution |
| Al | 4.4 | 64.1 |
| Co | 0.11 | 99.4 |
| Cu | 0.52 | 95.0 |
| Fe | 0.006 | 99.0 |
| Li | 0.03 | 99.7 |
| Mn | 0.02 | 99.6 |
| Ni | 0.66 | 98.9 |

Without wishing to be bound by theory, it is believed that in Example 6 0.59 mole Cu, corresponding to 1.17 equivalents of electrons (Cu→Cu+2e⁻), are oxidized by in total 2.03 mole CAM, corresponding to 2.30 equivalents of electrons (Li₍₁₊ₓ₎M₍₁₋ₓ₎O₂+(1+x)H⁺+(1+x)/(1−x) e⁻→+(1+x)/2 Li₂O+(1−x)MO+(1+x)/2 H₂O), without any air. The ratio (mol Cu)/(mol CAM) is 0.29 giving a n(e_{M}) of 0.26. Comparing of Examples 5 and 6 demonstrates a beneficial effect when CAM is added after the hydrogen evolution has ceased (Example 5). By contrast, adding the CAM right at the beginning of the reaction (Example 6) may reduce the efficiency of the copper oxidation by the CAM which may be due to a partial reduction of the CAM by the hydrogen evolved.

### Example 7

In this example, black mass was contacted with an acidic aqueous solution having a pH less than 6, air was not added, and an oxidizing agent of formula LiₚM_{q}M′ᵣOₛ, here CAM of formula Li₍ₓ₊₁₎(Ni_{0.34}Co_{0.32}Mn_{0.34})₍₁₋ₓ₎O₂ with x=0.0628, was added. The addition of the sulfuric acid was done under careful control of the pH-value of the leach solution to maintain a pH-value of about 1.5 throughout the reaction. Subsequently, no reducing agent (SO₂) was added.

In a reaction vessel equipped with a reflux condenser and a dropping funnel 910.8 g of black mass 2 was suspended in 2166 g of de-ionized water under an atmosphere of nitrogen. The reaction vessel had been flushed with nitrogen and kept under a constant stream of 20 normal liters per hour of nitrogen throughout the whole experiment. The reactor content was heated to 80° C. within 86 min. To this mixture, 312 g of sulfuric acid (96 w %) was slowly added within 30 min under stirring with a threefold cross beam stirrer at 500 rpm at a starting temperature of 25° C. to reduce the pH-value of the slurry from 12.3 to 2.1.

During this period, the temperature in the reactor was raised from 80° C. to 92° C. Hydrogen gas evolved and caused some foaming of the reaction mixture. The addition of sulfuric acid was carried on for the next 359 min while controlling the pH-value to keep it at about 1.5. 100 min after the start of the acid addition the temperature of the reactor was started to increase to about 100° C. which was reached 280 min after the start of the acid addition. At 409 min after the start of the acid addition, an additional 31 g of water were added to the reaction mixture. At 15 min later, a 1^{st} sample was taken, filtered, and analyzed. The wet filter residue contained 2.24% Ni, 0.36% Co, 0.007% Mn and 1.72% Cu while the filtrate contained 4.7% Ni, 1.6% Co, 0.08% Mn and 0.01% Cu.

Afterwards, the reactor was cooled down and kept at room temperature over night for 885 min. The next day, the reactor was heated up again to 100° C. within 108 min. At 195 min later, a 2^{nd} sample was taken and analyzed. The wet filter residue contained 0.79% Ni, 0.15% Co, 0.006% Mn and 1.77% Cu while the filtrate contained 5.7% Ni, 1.8% Co, 0.09% Mn and 0.01% Cu. These data demonstrate that nickel, cobalt, and manganese species were leached to a great extend at a pH-value of about 1.5 during the phase of pure acid leaching while copper was hardly dissolved.

After the 2^{nd} sampling, the reactor temperature was set to 90° C. which was reached after 67 min. At 82 min after the 2^{nd} sampling, 20.5 g of CAM and 11 g of water were added. A 3^{rd} sample was taken 30 min after the first CAM addition, but the analysis showed only minor changes. Therefore, 55 min after the first CAM addition another 21 g of CAM were added. At 38 min later a 4^{th} sample was taken and analyzed. Still the changes in concentrations were small; however, the Cu concentration in the filtrate raised to 0.2%.

The reactor was kept for an additional 32 min at 90° C. and then cooled down to keep it at room temperature overnight for 930 min. The reactor was then heated up again to 90° C. within 105 min and then 20.4 g of CAM were added. At 40 min later a 5^{th} sample was taken and analyzed, the wet filter residue contained 0.65% Ni, 0.09% Co, 0.02% Mn and 1.62% Cu while the filtrate contained 5.8% Ni, 1.6% Co, 0.3% Mn and 0.3% Cu. Within the following 265 min, an additional 50 g of CAM was added in 4 portions and also one portion of 11 g of water. At 30 min after the addition of the last CAM portion another sample was take and analyzed, the wet filter residue contained 0.41% Ni, 0.06% Co, 0.01% Mn and 0.26% Cu while the filtrate contained 5.2% Ni, 2.0% Co, 0.4% Mn and 0.6% Cu the pH-value of the filtrate was 1.7. At 50 min after the last sampling, the heating of the reactor was switched off, 851 g of de-ionized water was added so that metal salts did not crystallize upon cooling down to room temperature. The slurry was then filtered to obtain 3602 g of filtrate. The reactor was flushed with 1003 g of water which was also filtered and unified with 5 additional washing filtrates of the filter residue (in total 4814 g). The wet filter cake had a mass of 640 g with a water content of 42.3%. The elemental composition of the filter residue and the calculated leaching recoveries are summarized in Table 8.

TABLE 8

| | Weight | Recovery |
|---|---|---|
| | Percent in | Percent |
| | Leach | in Leach |
| Element | Residue | Solution |
| Al | 4.4 | 57.5 |
| Co | 0.13 | 99.4 |
| Cu | 0.73 | 92.8 |
| Fe | 0.01 | 98.2 |
| Li | 0.04 | 99.6 |
| Mn | 0.03 | 99.5 |
| Ni | 0.8 | 98.6 |

Without wishing to be bound by theory, it is believed that in Example 7 0.59 mole Cu, corresponding to 1.18 equivalents of electrons (Cu→Cu+2e⁻), are oxidized by 1.2 mole CAM, corresponding to 1.36 equivalents of electrons (Li₍₁₊ₓ₎M₍₁₋ₓ₎O₂+(1+x)H⁺+(1+x)/(1−x) e⁻→+(1+x)/2 Li₂O+(1−x)MO+(1+x)/2 H₂O), without any air. The ratio (mol Cu)/(mol CAM) is 0.49 giving a n(e_{M}) of 0.43.

1. A method for leaching a material comprising copper in a zero oxidation state, wherein the method comprises:
contacting the material with an acidic aqueous solution having a pH less than 6 to form a leaching mixture, and
oxidizing the copper with an oxidizing agent of formula LiₚM_{q}M′ᵣOₛ; wherein:
M comprises one or more metals chosen from nickel, manganese, and cobalt, M′ comprises one or more metals chosen from Mg, Ca, Ba, Al, Ti, Zr, Zn, Fe, V, Mo, and W;
p ranges from 1 to 1.4;
q ranges from 0.6 to 2;
r ranges from 0 to 1;
s ranges from 2 to 4; and
a total amount of copper present in the material before leaching in moles divided by a total amount of the oxidizing agent in mols(Cu)/mols(OA), ranges from n(e_{M})/8 to 2 n(e_{M}); wherein
$$n ( {e}_{M} ) = \frac{2 ( s - q ) - p - r \cdot {Ox}_{{M}^{′}}}{q}$$
and Ox_{M}, is the average oxidation number of M′ determined by calculating the molar average of the most stable oxidation number for each metal, as an oxide, comprised by M′.

2. The method according to claim 1, wherein mols(Cu)/mols(OA) ranges from n(e_{M})/4 to n(e_{M}).

3. The method according to claim 1, wherein the oxidizing agent comprises lithiated nickel cobalt manganese oxide of formula Li₍₁₊ₓ₎(NiₐCo_{b}Mn_{c}M′_{d})₍₁₋ₓ₎O₂, wherein:
M′ is chosen from Mg, Ca, Ba, Al, Ti, Zr, Zn, Mo, V and Fe;
zero≤x≤0.2;
0.1≤a≤0.95,
zero≤b≤0.9, or 0.05<b≤0.5;
zero≤c≤0.6;
zero≤d≤0.1; and
$$a + b + c + d = 1 .$$

4. The method according to claim 1, wherein the oxidizing agent comprises lithiated nickel-cobalt aluminum oxides of formula Li[NiₕCoᵢAlⱼ]O₂₊ₜ, wherein:
h ranges from 0.8 to 0.95;
i ranges from 0.1 to 0.3;
j ranges from 0.01 to 0.10; and
t ranges from zero to 0.4.

5. The method according to claim 1, wherein the oxidizing agent comprises lithiated manganese oxides of formula
Li₍₁₊ₓ₎Mn_{2-X-y-z}M_{y}M′_{z}O₄, wherein:
x ranges from zero to 0.2;
y+z ranges from zero to 0.1; and
M′ is chosen from Al, Mg, Fe, Ti, V, Zr and Zn.

6. The method according to claim 1, wherein the oxidizing agent comprises a compound of formula xLi_{(1+1/3)}M_{(2/3)}O₂·yLiMO₂·zLiM′O₂, wherein M comprises at least one metal of oxidation state +4, M′ is at least one transition metal and 0<x<1, 0<y<1, 0<z<1 and x+y+z=1.

7. The method according to claim 1, wherein the material is a black mass from a lithium ion battery material and the oxidizing agent is a cathode active material.

8. The method according to claim 1, wherein at least 50% of the oxidizing agent is added to the leaching mixture after the contacting step; optionally wherein, at the contacting step, hydrogen gas evolves and at least 50% of the oxidizing agent is added to the leaching mixture after the hydrogen gas evolution rate decreases to 10% of a maximal hydrogen gas evolution rate during the contacting step.

9. The method according to claim 1, wherein the cathode active material oxidizes from 50% to 100% of the copper.

10. The method according to claim 1, further comprising adding an additional oxidizing agent comprising at least one chosen from O₂, N₂O, hydrogen peroxide, and peroxydisulfates to the leaching mixture; optionally wherein, at the contacting step, hydrogen gas evolves and the additional oxidizing agent is added to the leaching mixture after the hydrogen gas evolution rate decreases to 10% of a maximal hydrogen gas evolution rate during the contacting step.

11. The method according to claim 1, further comprising adding a reducing agent comprising at least one chosen from SO₂, metabisulfite salts, bisulfite salts, dithionate salts, thiosulfate salts, H₂O₂, and H₂ to the leaching mixture; optionally, wherein the reducing agent is added after at least 50% of the copper has been oxidized.

12. The method according to claim 1, wherein the acidic aqueous solution comprises at least one acid chosen from H₂SO₄, methane sulfonic acid, and nitric acid.

13. The method according to claim 1, wherein the acidic aqueous solution has an acid concentration ranging from 18 mol/L to 0.0001 mol/L.

14. The method according to claim 1, wherein the material comprises from 0.1 weight % to 10 weight % copper by total weight of the material.

15. A method comprising:
leaching a material according to claim 1 to obtain an aqueous solution comprising metal ions, and
separating the metal ions to obtain at least one essentially pure metal ion solution and/or at least one essentially pure solid metal ion salt.

16. A method for recycling at least one battery material chosen from a lithium ion battery, lithium ion battery waste, lithium ion battery production scrap, lithium ion cell production scrap, lithium ion cathode active material, and combinations thereof, wherein the method comprises:
optionally, heat treating the at least one battery material at a temperature ranging from 350° C. to 900° C.,
mechanically comminuting the at least one battery material to obtain a black mass, optionally, sorting the black mass to obtain a fine fraction and a coarse fraction, and subjecting the black mass, optionally the fine fraction, the coarse fraction, or the fine fraction and the coarse fraction, to the method according to claim 1.

17. The method for leaching a material comprising copper in a zero oxidation state according to claim 1, wherein the method comprises: contacting the material with an acidic aqueous solution having a pH less than 6 to form a leaching mixture, and oxidizing the copper with an oxidizing agent of formula LiₚM_{q}M′ᵣOₛ; wherein: M is one or more metals chosen from nickel, manganese, and cobalt, M′ is one or more metals chosen from Mg, Ca, Ba, Al, Ti, Zr, Zn, Fe, V, Mo, and W; p ranges from 1 to 1.4; q ranges from 0.6 to 2; r ranges from 0 to 1; s ranges from 2 to 4; and a total amount of copper present in the material before leaching in moles divided by a total amount of the oxidizing agent in moles, mols(Cu)/mols(OA), ranges from n(e_{M})/8 to 2 n(e_{M}); wherein
$$n ( {e}_{M} ) = \frac{2 ( s - q ) - p - r \cdot {Ox}_{{M}^{′}}}{q}$$
and Ox_{M}, is the average oxidation number of M′ determined by calculating the molar average of the most stable oxidation number for each metal, as an oxide, comprised by M′.

18. The method for leaching a material comprising copper in a zero oxidization state according to claim 1, wherein the method comprises: contacting the material with an acidic aqueous solution having a pH less than 6 to form a leaching mixture, and oxidizing the copper with a cathode active material of formula Li(₁₊ₓ₎M₍₁₋ₓ₎O₂; wherein: M comprises nickel and cobalt; x ranges from 0 to 0.5; and a total amount of the copper in moles divided by a total amount of the cathode active material in moles, mols(Cu)/mols(CAM), ranges from
$$\frac{( 1 + x )}{4 ( 1 - x )} to \frac{( 1 + x )}{( 1 - x )} .$$
